(19) United States
(12) Patent Application Publication
(10) Pub. No.: US 2004/0208980 A1
(43) Pub. Date: Oct. 21, 2004

(54) Ambient stable starch product

(75) Inventors: Thomas Vincent Merolla, Hillsborough, NJ (US); Bernard Charles Sekula, Glen Gardner, NJ (US)

Correspondence Address: UNILEVER, PATENT DEPARTMENT, 45 RIVER ROAD, EDGEWATER, NJ, 07020, US

(73) Assignee: Unilever Bestfoods North America

(21) Appl. No.: 10/417,058

(22) Filed: Apr. 16, 2003

(51) Int. Cl. A23G 3/00

(52) U.S. Cl. 426/658

(57) ABSTRACT

The present invention is directed to an ambient stable and starch-comprising food product. The food product has a base component with at least 8.0% by weight carbohydrate, at least 0.2% by weight amylose and no more than 12.5% by weight amylose. The food product is ambient stable and is not sour, even at a pH below 4.25.

### FIELD OF THE INVENTION

The present invention is directed to an ambient stable and starch-comprising food product. More particularly, the invention is directed to a starch-comprising food product that is stable at ambient temperature and not sour, even at a pH below about 4.25. The starch-comprising food product comprises at least about 8.0% by weight carbohydrate, at least about 0.02% by weight amylose, and no more than about 12.5% by weight protein, based on total weight of base component within the starch-comprising food product.

### BACKGROUND OF THE INVENTION

Many conventional starch-comprising products, like mashed potato, humus, and comminuted vegetables are desired by consumers. Such conventional starch-comprising products, however, can be difficult to freshly prepare, and pre-packaged versions of the same typically require refrigeration and have limited shelf life.

Other drawbacks associated with conventional starch-comprising products are the lack of microbiological stability, the difficulty in packaging large quantities for food service applications, and the often required need for pasteurization which leads to products with inferior flavor and nutritional characteristics.

It is of increasing interest, therefore, to develop a good tasting starch-comprising food product that is stable at ambient temperature. This invention, therefore, is directed to an ambient stable starch-comprising food product. The ambient stable starch-comprising food product is not sour at a pH below about 4.25 and may be served hot or cold.

### ADDITIONAL INFORMATION

Efforts have been disclosed for making starch-comprising food products. In U.S. Pat. No. 5,229,157, an aerated vegetable product comprising starch and oil is described.

Other efforts have been disclosed for making starch-comprising food products. In U.S. Pat. No. 5,536,525, an instant mashed potato product is disclosed.

Still other efforts have been disclosed for making starch-comprising food products. In U.S. Patent Application No. 2002/0155207 A1, a potato mash suitable to make mashed potatoes and potato patties is described.

None of the additional information above describes a starch-comprising food product that is stable at ambient temperature and is not sour at a pH below about 4.25.

### SUMMARY OF THE INVENTION

In a first aspect, the present invention is directed to an ambient stable and starch-comprising food product comprising:

(a) a base component comprising at least about 8.0% by weight carbohydrate, at least about 0.02% by weight amylose, and no more than about 12.5% by weight protein, all being based on total weight of the base component; and

(b) an acidulant

wherein the starch-comprising food product is not sour at a pH below about 4.25.

In a second aspect, the present invention is directed to the starch-comprising food product of the first aspect of this invention packaged in a ready-to-serve package.

Starch-comprising as used herein means comprising at least about 0.02% by weight amylose (based on total weight of the base component in the food product) whereby the amylose is naturally found in the base component and not added as a separate component like instant starch and cook-up starch. Not sour means no more sour than a starch-comprising food product having a pH of about 5.0. Ambient stable means microbiologically stable (i.e., no outgrowth of bacteria, yeast and/or mold) and no flavor loss for at least about five (5) weeks, and preferably, for at least about eight (8) weeks. Ambient stable also means that no phase separation is observed (e.g., synersis and/or creaming) for at least about eight (8) weeks. Base component means the mashed and/or granulated base that generates and is responsible for the characteristic flavor of the starch-comprising food product.

### DETAILED DESCRIPTION OF THE PREFERRED EMBODIMENTS

The only limitation with respect to the starch-comprising food product of this invention is that the food product comprises a base component with at least about 0.02 by weight amylose, at least about 8.0% by weight carbohydrate, less than about 12.5% by weight protein, and can be acidified to a pH below about 4.25 without having a sour taste. In a preferred embodiment, the base component of this invention has at least about 15.0% by weight carbohydrate, and most preferably, from about 20.0 to about 40.0% by weight carbohydrate, based on total weight of the base component. In another preferred embodiment, the base component comprises from about 0.5 to about 10.0% by weight protein, based on total weight of the base component. Illustrative examples of the source of base component employable in this invention include flour, oat meal, rice, corn meal, vegetable, legume or mixtures thereof. The flour may be white, bleached, whole wheat, semolina, a mixture thereof or the like. The vegetable is preferably one having less than about 1.0% by weight inulin, based on total weight of the vegetable. The vegetable may be potato (including sweet), corn, yam, beans, beets, cassaya, taro, parsnip, salsify, a mixture thereof or the like. The legumes employed in this invention are often peas, chick peas or mixtures thereof or the like. The preferred source of amylose (i.e., base component) employable in this invention is potato, and for example, any of those selected from the group consisting of russet, yukon gold, round white, red skinned, yellow fleshed and sweet potato. Other preferred sources of amylose employable in this invention are beans, chick pea and couscous. The most preferred source of amylose used in this invention is the russet potato.

The ambient stable starch-comprising food product of this invention may be made by first starting with base component in dehydrated raw material form. Such a dehydrated base component typically is from about 3.0 to about 15.0%, and preferably, from about 5.0 to about 13.0%, and most preferably, from about 7.0 to about 12.0% by weight water, based on total weight of the base component in dehydrated raw material form and including all ranges subsumed therein. In its hydrated form, the base component suitable for use in this invention is typically from about 50.0 to 90.0%, and preferably, from about 55.0 to about 85.0%, and most preferably, from about 60.0 to about 80.0% by weight water, based on total weight of the base component and including all ranges subsumed therein.

The ambient stable starch-comprising food product of this invention typically comprises from about 30.0 to about 98.0%, and preferably, from about 40.0 to about 95.0%, and most preferably, from about 50.0 to about 90.0% by weight water, based on total weight of the food product and including all ranges subsumed therein.

Regarding the amount of base component used, the ambient stable starch comprising food product of the present invention typically comprises from about 40.0 to about 95.0%, and preferably, from about 50.0 to about 90.0%, and most preferably, from about 60.0 to about 80.0% by weight hydrated base component, based on total weight of the food product and including all ranges subsumed therein.

The acidulants suitable for use in this invention are limited only to the extent that they may be used in a product suitable for human consumption. Examples of the types of acidulants that may be used in this invention are inorganic acids such as hydrochloric and phosphoric acid and organic acids like acetic acid, lactic acid, malic acid, glucono-delta-lactone, citric acid, mixtures thereof, and the like. The acidulant employed in this invention is added in an amount to preferably give the ambient stable and starch comprising food product a pH of less than about 4.25, and preferably, a pH of less than about 4.0, and most preferably, a pH from about 2.75 to about 3.90, including all ranges subsumed therein. Typically, therefore, the amount of acidulant added is from about 0.1 to about 1.5% by weight acid, (i.e., acid in undiluted form) based on total weight of the ambient stable and starch-comprising food product. In a preferred embodiment, the acidulant employed in this invention is a mixture of hydrochloric or phosphoric acid and an organic, with the organic acid making up no more than about 50.0% by weight of the total weight of the acidulant mixture. In yet another preferred embodiment, the ambient stable and starch-comprising food product of this invention is substantially free of vinegar (acetic acid) whereby substantially free means less than about 0.1% by weight based on total weight of the food product. In a most preferred embodiment, the food product of this invention has no vinegar.

Food grade starches (i.e., modified, non-modified, instant or cook-up) may also be employed in this invention. Such starches (e.g., corn, waxy maize, potato, rice, tapioca, wheat or mixtures thereof) are known thickening agents and often made commercially available from suppliers like National Starch and Chemical Company and E.W. Staley Manufacturing Company. Instant starches are the generally preferred starches used with Ultrasperse® from National Starch and Chemical being especially preferred. The amount of starch used in the food product of the present invention is usually from about 0.2 to about 4.0% by weight starch, based on total weight of the food product, and including all ranges subsumed therein.

Sweeteners may be used in this invention and they include, for example, syrups, sucrose, glucose, saccharin, aspartame, dextrose, lactose, maltose, fructose, mixtures thereof and the like. When employed, such sweeteners typically make up less than about 10.0% by weight of the total weight of the ambient stable and starch-comprising food product.

Protein may be employed in this invention. Sources of protein preferred for use are whey, soy, caseinate or a mixture thereof. The amount of protein used in the food product is limited only to the extent that the amount added does not interfere with the desired flavor of the food product and the pH impact of the acidulant. Typically, the amount of protein as an additive is less than about 5.0% by weight of the total weight of the food product.

The ambient stable and starch-comprising food product of this invention can comprise oil. Illustrative examples of the oil (e.g., fat) which may be used in this invention include avocado, coconut, corn, cottonseed, fish, flaxseed, grape, olive, palm, peanut, rapeseed, safflower, sesame, soybean, sunflower oil, mixtures thereof or the like. In a preferred embodiment, the oil used in this invention is liquid at ambient temperature, and most preferably, soybean oil. When oil is desired, the amount of oil used is typically from about 5.0 to about 40.0%, and preferably, from about 10.0 to about 30.0%, and most preferably, from about 15.0 to about 25.0% by weight oil, based on total weight of the food product and including all ranges subsumed therein.

It is noted that in lieu of oil or in combination with oil, conventional fat substitutes may be used. Preferred fat substitutes employable in this invention include fatty acid-esterified alkoxylated glycerin compositions as well as sucrose fatty acid esters. The former and latter are described in U.S. Pat. Nos. 5,516,544 and 6,447,824, respectively, the disclosures of which are incorporated herein by reference. When employed, such conventional fat substitutes preferably make up at least about 30.0%, and most preferably, at least about 75.0% of the total weight of the oil in the food product.

Other optional additives which may be employed in the food product of the present invention include salt (and other spices and seasonings), vitamins, artificial flavors and colors, fruit puree, gums, preservatives, emulsifiers, antioxidants, chelators, meat like ham and bacon bits or particulates, buffering agents, vegetable bits or particulates, fruit bits or particulates, seeds, nuts, mixtures thereof and the like. Such optional additives, when used, collectively, do not make up more than about 20.0% by weight of the total weight of the food product. Water makes up the balance of the food product.

Illustrative examples of the preferred gums suitable for use in this invention include cellulose, locust bean, xanthan, carrageenan, guar gum, mixtures thereof and the like. The preferred preservatives suitable for use in this invention include sodium benzoate, potassium benzoate, potassium sorbate, sorbic acid, benzoic acid, mixtures thereof and the like.

Antioxidants suitable for use in this invention include tocopherols, ascorbic acid, ascorbyl palmitate, propyl galate, tertiary-butyl hydroquinone, mixtures thereof and the like. Chelators suitable for use in this invention include EDTA and its salts, citric acid, sodium tripolyphosphate, sodium carbonate, potassium carbonate, mixtures thereof and the like.

The fruit and vegetable bits that may be used in this invention are typically small enough to not interfere with spreading with a knife. The vegetable bits often include peppers, carrots, cabbage, onion, broccoli, mixtures thereof and the like. The fruit bits often include pears, apples, grapes, tomatoes, mixtures thereof and the like.

If desired, the emulsifier that may be used in the food product of this invention often has an HLB of greater than about 9.0, and preferably, greater than about 11.0, and most preferably, from about 12.0 to about 18.0, including all ranges subsumed therein. Examples of the emulsifier suitable for use in this invention include PEG 20 tristearate, PEG 20 trioleate, PEG 20 monostearate, PEG 20 monooleate, PEG 20 monopalmitate and PEG 20 monolaurate sorbitan, derivatives thereof, mixtures thereof and the like, all made commercially available by ICI Surfactants under the names Tween or Span.

Other emulsifiers that may be used in this invention include nonionic copolymers of ethylene oxide and propylene oxide made available under the name Pluronic by BASF AG. Even other emulsifiers that may be used in this invention include lecithin and mono- and diglycerides, as well as polyglycerol polyricinoleate (PGPR). The preferred emulsifiers employable in this invention are, however, polysorbate 60, or phospholipid, and especially, egg yolk derived phospholipids modified with a phospholipase (e.g., lecitase from Novo Nordisk) as disclosed in U.S. Pat. Nos. 5,028,447, 6,277,430, the disclosures of which are incorporated herein by reference. Suppliers of such phospholipids are, for example, M.G. Waldbaum Company and Inova Food Ingredients.

The amount of emulsifier employed in the ambient stable and starch-comprising food product of this invention is typically from about 0.05 to about 6.0%, and preferably, from about 0.1% to about 4.0%, and most preferably, from about 0.2 to about 3.0% by weight emulsifier, based on total weight of the food product and including all ranges subsumed therein.

Regarding the seeds and nuts that may be optionally added to the ambient stable and starch-comprising food product of this invention, such seeds and nuts may be added as a paste, particulates or whole. The preferred seeds for use in this invention include poppy seeds, sesame seeds, anise seeds, mixtures thereof and the like. The preferred nuts suitable for use in this invention are almonds, peanuts, walnuts, macadamia, mixtures thereof and the like. When employed, the total amount of seeds, nuts or both in the food product of this invention does exceed about 15.0% by weight of the total weight of the food product.

When making the ambient stable and starch-comprising food product of the present invention, the ingredients can typically be combined, in no particular order, then mixed to produce a homogenous, ambient stable and starch-comprising food product suitable for consumption, either hot or cold.

In a preferred embodiment, the food product of the present invention is made by combining all liquid ingredients followed by the addition of base component in powder or flake form (i.e., dehydrated raw material form). In another preferred embodiment, the acidulant employed is diluted with water and added last.

The ambient stable and starch-comprising food product of this invention may be packed, for example, in a glass jar, food grade pack or sachet, or a squeezable plastic bottle. Such a product is suitable for domestic and food service applications.

The examples which follow are provided to facilitate an understanding of the present invention. The examples are not intended to limit the scope of the claims.

### EXAMPLE 1

Mashed potatoes were prepared as follows:

| Ingredient | Weight % |
|---|---|
| Soybean Oil | 22.0-24.0 |
| Potato Flakes | 12.0-14.0 |
| Sugar | 2.5-3.0 |
| Lactic Acid (50% solution) | 0.70-0.85 |
| Salt | 0.58-0.68 |
| Butter Flavor | 0.13-0.19 |
| Pepper | 0.05-0.10 |
| Water | Balance |

When preparing the mashed potatoes, water was heated to boiling and lactic acid, salt, sugar and pepper were added to make a hot solution. Potato flakes were added to the hot solution with stirring, resulting in potato paste. Soybean oil was slowly added to the potato paste, with stirring, resulting in the starch-comprising food products of this invention, with pH values being between 3.7 and 3.9. Glass jars (8 oz.) were filled with the mashed potato and tightly capped.

### EXAMPLE 2

Bean purees were prepared as follows:

| Ingredient | Weight % |
|---|---|
| White kidney beans (canned) | Balance |
| Garlic | 1.45-1.65 |
| Lemon juice (fresh) | 0.40-0.50 |
| Salt | 1.15-1.25 |
| Phosphoric acid (85% solution) | 0.9-1.1 |
| Sugar | 4.4-4.6 |
| Sesami tahini | 11.5-12.5 |

Crushed garlic, tahini and lemon juice were mixed in a food processor until a puree was produced. White kidney beans were added and mixed in to the purees, producing bean puree. Salt, sugar and phosphoric acid were subsequently mixed in to the bean puree, and the resulting food products had pH values between 3.7 and 3.9. Glass jars (8 oz.) were filled with the bean puree and tightly capped.

### EXAMPLE 3

Six (6) panelists sampled the starch-comprising food products made in Examples 1 and 2. The panelists unexpectedly concluded that the food products were not sour and had good flavor, even after being placed at ambient temperature for about one (1) week.

### EXAMPLE 4

The food products of Examples 1 and 2 may be formulated with about 0.10-0.20% by weight sorbic acid (preservative) and about 1.5 to about 2.5% by weight stabilizer (i.e., food grade starch and/or gum) to result in an ambient stable food product that is expected to show no creaming and/or syneresis, and no outgrowth of bacteria, yeast and/or mold for at least about eight (8) weeks (at ambient temperature). Such a conclusion cannot be made for conventional products which typically have a pH of greater than about 5.0.

What is claimed:

1. An ambient stable and starch-comprising food product comprising:
(a) a base component comprising at least about 8.0% by weight carbohydrate, at least about 0.02% by weight amylose, and no more than about 12.5% by weight protein, all being based on total weight of the base component; and
(b) an acidulant
wherein the starch-comprising food product is not sour at a pH below about 4.25.

2. The ambient stable and starch-comprising food product according to claim 1 wherein amylose is naturally found in the base component.

3. The ambient stable and starch-comprising food product according to claim 1 wherein the base component comprises flour, oatmeal, rice, corn meal, vegetable, legume or mixtures thereof.

4. The ambient stable and starch-comprising food product according to claim 3 wherein the flour is white, bleached, whole wheat, semolina, or a mixture thereof.

5. The ambient stable and starch-comprising food product according to claim 3 wherein the base component is couscous.

6. The ambient stable and starch-comprising food product according to claim 3 wherein the base component is vegetable and selected from the group consisting of potato, sweet potato, corn, yam, beans, beets, cassaya, taro, parsnip, salsify, and a mixture thereof.

7. The ambient stable and starch-comprising food product according to claim 3 wherein the base component is a legume and selected from the group consisting of peas or chick peas.

8. The ambient stable and starch-comprising food product according to claim 1 wherein the food product is mashed potato, humus or bean puree.

9. The ambient stable and starch-comprising food product according to claim 1 wherein the base component, in hydrated form, comprises about 50.0 to about 90.0% by weight water.

10. The ambient stable and starch-comprising food product according to claim 1 wherein the food product comprises about 30.0 to about 98.0% by weight water.

11. The ambient stable and starch-comprising food product according to claim 1 wherein the food product has a pH between about 2.75 and 3.90.

12. The ambient stable and starch-comprising food product according to claim 1 wherein the food product further comprises a thickening agent, sweetener, protein, oil, fat substitute or a mixture thereof.

13. The ambient stable and starch-comprising food product according to claim 1 wherein the food product further comprises vitamins, artificial flavors, food coloring, fruit puree, gum, preservative, emulsifier, antioxidant, chelator, meat, fruit bits or particulates, vegetable bits or particulates, seeds, nuts or a mixture thereof.

14. The ambient stable and starch-comprising food product according to claim 1 wherein the food product comprises from about 0.1 to 1.5% by weight acidulant.

15. A packaged, ambient stable and starch-comprising food product comprising:
(a) a base component comprising at least about 8.0% by weight carbohydrate, at least about 0.02% by weight amylose, and no more than about 12.5% by weight protein, all being based on total weight of the base component; and
(b) an acidulant
wherein the food product is not sour at a pH below about 4.25, may be served hot or cold, and is packaged in ajar, food grade pack or sachet or squeezable bottle.

16. The packaged food product of claim 15 wherein the food product is mashed potato, bean puree, or humus.

17. The packaged food product according to claim 15 wherein the packaged food product further comprises nuts, seeds, oil or a mixture thereof.

18. The packaged food product according to claim 15 wherein, during manufacturing, the acidulant is added to the food product last.
